(19) United States
(12) Patent Application Publication
(10) Pub. No.: US 2013/0155672 A1
(43) Pub. Date: Jun. 20, 2013

(54) REMOTE CONTROL TRACK LIGHT FIXTURE

(71) Applicants: Vung Van Vo, San Antonio, TX (US); Mark R. Lesher, San Antonio, TX (US); Steven A. Moya, San Antonio, TX (US); Michelle Kun Huang, San Antonio, TX (US)

(72) Inventors: Vung Van Vo, San Antonio, TX (US); Mark R. Lesher, San Antonio, TX (US); Steven A. Moya, San Antonio, TX (US); Michelle Kun Huang, San Antonio, TX (US)

(73) Assignee: GENERAL LED, INC., San Antonio, TX (US)

(21) Appl. No.: 13/366,263

(22) Filed: Feb. 3, 2012

Related U.S. Application Data
(60) Provisional application No. 61/452,058, filed on Mar. 11, 2011.

(51) Int. Cl. F21S 8/00

(52) U.S. Cl. CPC F21S 8/00
USPC 362/233; 362/382; 362/383; 398/106; 340/12.22

(57) ABSTRACT

A track head unit includes a lighting device, a first sensor, a second sensor, one or more motors, and a controller. The first sensor is configured to receive transmissions from a portable remote control device. The second sensor is configured to receive transmissions associated with a target object. The one or more motors are mechanically coupled to the lighting device and is configured to position the lighting device along a first direction and a second direction. The controller is coupled to the lighting device, the first sensor, the second sensor, and the one or more motors. The controller is configured to receive a control signal from the remote control device via the first sensor, responsively transmit a locator signal to a locator that is disposed at a target object, receive a response signal via the second sensor from the remote object in response to the transmitting, and based upon the response signal, actuate the motors to aim the lighting device at the target object.

### CROSS REFERENCES TO RELATED APPLICATIONS

This application claims benefit under 35 U.S.C. §119 (e) to U.S. Provisional Application No. 61/452,058 entitled “Remote Control Track Light Fixture” filed Mar. 11, 2011 having attorney docket number 3962.037, the content of which is incorporated herein by reference in its entirety.

### FIELD OF INVENTION

The present invention relates to an apparatus for facilitating the remote positioning of a track-light fixture. In particular, this invention involves a method and apparatus for use in remotely positioning a track-light fixture through the use of one or more automatically or remotely controlled electric motors.

### BACKGROUND OF THE INVENTION

Track light fixtures are commonly used in lighting applications that require the ability to aim a light source at a target of illumination. As such, track light systems are used in a wide range of residential, office, commercial and institutional applications where it is desirable to illuminate specific areas in addition to illuminating an entire room Thus, track light systems are widely employed in museums and art galleries where specific wall hangings are to be illuminated and accented. Similarly, track light systems are commonly employed to emphasize commercial displays in retail establishments, architectural displays in office buildings, specific tables in a restaurant and various other items of interest or importance.

A typical track light fixture includes a linear track that is fixed to mounting location such as a ceiling or wall and is mechanically cooperated with one or more track heads. The track heads contain a mechanical arm that is connected at one end to the track and connected at the other end to a bulb housing containing at least one laser and a light bulb. The bulb housing and light bulb situated therein are manually adjustable for aiming the emitted light toward a target of illumination. Once proper positioning is accomplished, a screw is generally used to fix the position or orientation of the bulb housing, thereby fixing the direction of light emitted by the light bulb. However, when a target of illumination is moved (e.g., moving a displayed painting or an item of shelved merchandise etc.) the bulb housing must again be adjusted to re-focus the light on the desired target. Because track light adjustments must be made manually, this process will often involve a person mounting a ladder in order to approach the track head in order to loosen a screw and adjust the bulb housing to the newly desired position.

The manual adjustment of track lighting can be particularly onerous in lighting applications where illumination targets are moved or rearranged on a frequent basis. For example, in merchandise displays that must be changed seasonally or in response to special sales events that require frequent lighting adjustments.

### BRIEF SUMMARY OF THE INVENTION

Approaches are provided that aim a lighting device at a target object without the need for manually adjusting the light. The approaches described herein are easy and cost effective to implement and significantly reduce or eliminate the disadvantages of previous approaches.

In some of these embodiments, a track-light module includes: a track head; a light source, wherein the light source is mechanically coupled to the track head; a first electric motor, wherein the first electric motor is mechanically coupled to the track head and configured to position the light source along a first direction; a second electric motor, wherein the second electric motor is mechanically coupled to the track head and configured to position the light source along a second direction; at least one laser source, wherein the laser source is mechanically coupled to the track head; and a control circuit, wherein the control circuit is configured to receive one or more wireless control signals for controlling operation of at least one of the first electric motor and the second electric motor.

In others of these embodiments, an approach for positioning a track-light module comprising the steps of: positioning a light source in a first orientation; emitting light from the light source; measuring, using one or more optical sensors, a first backscatter illumination intensity that is dispersed from an illumination target; positioning the light source in a second orientation, wherein the second orientation is different from the first orientation; measuring, using the one or more optical sensors, a second backscatter illumination intensity; and comparing the first backscatter illumination intensity and the second backscatter illumination intensity.

In still others of these embodiments, a handheld control unit includes: a memory; a microprocessor electrically coupled to the memory and configured to receive and store information, wherein the information comprises track head position settings; and transmitter circuitry, electrically coupled to the microprocessor and wherein the transmitter circuitry is configured to transmit at least a portion of the information to a track head control circuit.

In yet others of these embodiments, a track-light module includes a track and a track head. The track head unit is coupled to the track and includes a lighting device; a first electric motor that is mechanically coupled to the lighting device and configured to position the lighting device along a first direction; a second electric motor mechanically coupled to the lighting device and configured to position the lighting device along a second direction; and a controller. The controller is configured to receive one or more wireless control signals for controlling operation of at least one of the first electric motor and the second electric motor.

In some aspects, the controller receives location information indicating a target object. In other aspects, the controller is configured to actuate one or more of the first motor and the second motor to adjust a position of the lighting device to illuminate the target object in response to receiving the information. In some examples, the controller further comprises an optical sensor for detecting backscatter illumination. In other examples, the first electric motor is configured to position the light source along a tilt axis. In still other examples, the second electric motor is configured to position the light source along a pan access. In other aspects, the controller further includes a laser source and wherein the controller is coupled to the laser source and is further configured to receive one or more control signals for activating or de-activating the laser source.

In some examples, the one or more wireless control signals includes a radio-frequency (RF) signal, a Bluetooth signal, or a Zigbee signal. In other aspects, the one or more wireless control signals is an infra-red (IR) signal. In one example, the lighting device comprises at least one light-emitting diode (LED). In another example, the lighting device comprises a LED type PAR-30 lamp.

In others of these embodiments, at a lighting control unit, a control signal from a remote control device is received. The lighting control unit is then responsively activated to control a lighting device. Subsequent to the activation, a locator signal is transmitted to a locator on a target object. A response signal is received from the remote object in response to the transmission. Based upon the response signal, one or more axis motors are adjusted to aim the lighting device and illuminate the target object.

In one aspect, the one or more axis motors include a single motor that adjusts the position of the lighting device relative to a pan axis and a tilt axis. In another aspect, the one or more axis motors include a first motor that adjusts a position of the lighting device along a pan axis and a second motor that adjusts the position of the lighting device along a tilt axis.

In some examples, the locator may be a passive locator or an active locator. In other examples, the locator signal comprises transmitting a laser signal. In still other examples, the control signal comprises a laser signal or an infrared signal. In yet other examples, the response signal includes back-scattered radiation.

In others of these embodiments, a track head unit that is configured to be coupled to a track includes a lighting device, a first sensor, a second sensor, one or more motors; and a controller. The first sensor is configured to receive transmissions from a portable remote control device. The second sensor is configured to receive transmissions associated with a target object. The one or more motors are mechanically coupled to the lighting device and is configured to position the lighting device along a first direction and a second direction. The controller is coupled to the lighting device, the first sensor, the second sensor, and the one or more motors. The controller is configured to receive a control signal from the remote control device via the first sensor, responsively transmit a locator signal to a locator that is disposed at a target object, receive a response signal via the second sensor from the remote object in response to the transmitting, and based upon the response signal, actuate the motors to aim the lighting device at the target object.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure:

FIG. 1A is a simplified side view of a track light system, including a track light rail according to an embodiment of the present invention;

FIG. 1B is a perspective view of the track head depicted in FIG. 1A, without the track light rail;

FIG. 2 is a cut-away side view of the track head depicted in FIGS. 1A and B;

FIG. 3 is a cut-away top view of the track head as depicted in FIGS. 1A and B;

FIG. 4 is a front perspective view of a bulb housing which contains a laser source;

FIG. 5 depicts a block diagram of a control circuit according to one embodiment of the present invention;

FIG. 6 depicts the cut-away side view of the track head depicted in FIG. 3, together with a laser beam axis;

FIG. 7 depicts a flow diagram that illustrates steps for remotely positioning a track head according to some preferred embodiments of the present invention;

FIG. 8 depicts a flow chart of steps for a method of positioning a light source according to some embodiments of the present invention;

FIG. 9 is a block diagram of the circuit components of a hand-unit according to some embodiments of the present invention;

FIG. 10 depicts a side profile view of a single motor drive mechanism according to one embodiment of the invention;

FIG. 11 depicts a top view of a single motor drive mechanism according to one embodiment of the invention;

FIG. 12 depicts a top view of the single motor drive mechanism of FIG. 11 according to one preferred embodiment of the invention;

FIG. 13 comprises a block diagram of a track lighting system according to various embodiments of the present invention;

FIG. 14 comprises a flowchart of an approach for operating a track lighting system according to various embodiments of the present invention;

FIG. 15 comprises a block diagram for an active aiming system in a track lighting system according to various embodiments of the present invention;

FIG. 16 comprises a flow chart for providing an active aiming system in a track lighting system according to various embodiments of the present invention;

FIG. 17 comprises a block diagram for an active aiming system in a track lighting system according to various embodiments of the present invention;

FIG. 18 comprises a flow chart for providing an active aiming system in a track lighting system according to various embodiments of the present invention;

FIG. 19 comprises a block diagram for a passive aiming system in a track lighting system according to various embodiments of the present invention;

FIG. 20 comprises a block diagram for a passive aiming system in a track lighting system according to various embodiments of the present invention;

FIGS. 21-26 comprise views of and diagrams illustrating the operation of a single motor track lighting system according to various embodiments of the present invention;

FIG. 27 comprises a magnetic clutch system used in a lighting system according to various embodiments of the present invention.

### DETAILED DESCRIPTION

Reference will now be made in detail to certain embodiments of the present disclosure, examples of which are illustrated in the accompanying figures. It is to be understood that the figures and descriptions of the present disclosure included herein illustrate and describe elements that are of particular relevance to the present disclosure, while eliminating, for the sake of clarity, other elements found in typical track light systems.

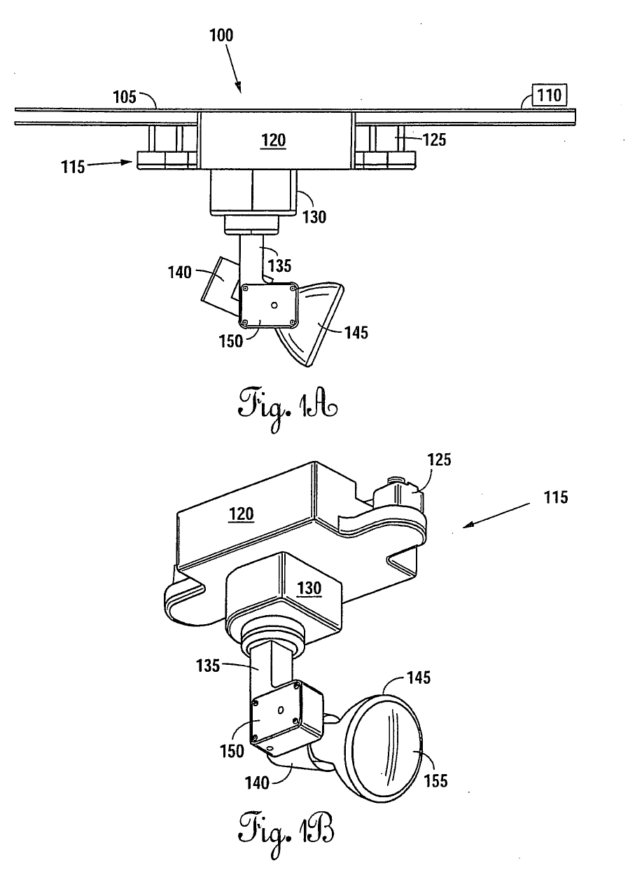

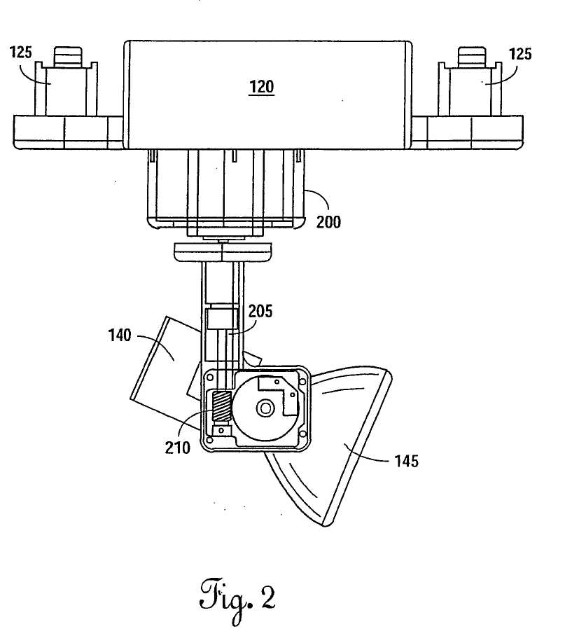

FIG. 1 is a side view of a complete track light system 100 according to one embodiment of the present invention. The depicted track light system 100 includes a track light rail 105 together with a power supply 110. In preferred embodiments, the track light rail 105 will be electrically cooperated with a track light head 115 comprising: a main housing 120, track contactors 125, a tilt axis drive location 130, a mechanical arm 135, a lamp fixture 140, a bulb housing 145 and a tilt axis control assembly 150.

In preferred embodiments, power supply 110 is electrically coupled to the track light rail 105 via one or more track contactors 125. The track contactors 125 provide mechanical support to the remaining portions of the track head 115 via cooperation with the main housing 120 and the track light rail 105. Furthermore, the main housing 120 is electrically and mechanically cooperated with the tilt axis drive location 130 that is connected to the mechanical arm 135. The lower portion of mechanical arm 135 is further attached to the lamp fixture 140 and tilt axis control assembly 150. Bulb housing 145 is mechanically cooperated with lamp fixture 140.

In one embodiment of the present invention the power supply 110 will comprise a DC power source for delivering a DC power signal to the track light rail 105. For example, power supply 110 may comprise an AC/DC power transformer for producing a DC signal from an AC input source. In preferred embodiments, power can be delivered to track head 115 via one or more of the track contactors 125 coupled to the track light rail 105; in turn, a power signal can be delivered to other components such as the main housing 120, tilt axis control assembly 150 and one or more light sources, as further discussed below.

FIG. 1B provides a perspective view of the track head 115 introduced in FIG. 1A. Further illustrated is a light source 155 positioned within bulb housing 145. The light source is mechanically and electrically cooperated with lamp fixture 140 and may comprise essentially any type of light-bulb or LED light engine. For example, in some embodiments, the light source 155 may comprise one or more light-bulbs for emitting illumination from the bulb housing 145. In some embodiments, the light source 155 may comprise one or more LEDs either alone or in conjunction with one or more light bulbs, as mentioned above. In one preferred embodiment, the light source 155 comprises a LED type PAR-30 lamp.

In practice, the present invention allows for the adjustment of light source 155 along two axes: a tilt axis and a pan axis. As will be discussed in further detail below, embodiments of the present invention allow a user to remotely adjust the light source 155 along a tilt axis using one or more motors disposed in the tilt axis control assembly 150. For example, in one preferred embodiment, the position of the bulb housing 145 (and light source 155 disposed therein) may be adjusted through an arc of 90 degrees or more. In some embodiments, the position of light source 155 may be adjusted along only the tilt axis; however, in other embodiments tilt axis adjustments may occur in conjunction with adjustments along a pan axis. As will be discussed in further detail below, in some embodiments, pan axis adjustments may be made using one or more motors disposed within the main housing 120. For example, in one preferred embodiment, the pan axis position of light source 155 may be adjusted through almost 360 degrees of rotation.

Turning now to FIG. 2 which illustrates a side perspective view of a track head 115, with portions of the outer cover removed. Illustrated are the following: main housing 120, track contactors 125, lamp fixture 140, bulb housing 145, a tilt axis drive motor 200, a tilt axis drive shaft 205 and a tilt axis worm gear 210. In preferred embodiments of the present invention, the tilt axis drive motor 200 is mechanically cooperated with an upper portion of the tilt axis drive shaft 205; a lower portion of the tilt axis drive shaft is also mechanically cooperated with the tilt axis worm gear 210.

In some implementations, initialization of the tilt axis drive motor 200 will cause rotation of the tilt axis drive shaft 205 and tilt axis worm gear 210. In preferred embodiments, the tilt axis drive motor 200 may be configured for rotation in both directions allowing rotation of the tilt axis drive shaft 205 (and corresponding tilt axis worm gear 210) in both directions as well. As such, depending on the rotational direction of the tilt axis drive motor 200, the lamp fixture 140 may adjusted in either an upward or downward direction with respect to the tilt axis. By way of example, the tilt axis drive motor 200 can be configured to cause rotation of the tilt axis worm gear 210 in a first direction, causing movement of the lamp fixture 140 in an either an upward or downward direction with respect to the tilt axis. By way of further example, the tilt axis drive motor 200 may be rotated in a counter-clockwise direction causing movement of lamp fixture 140 in the opposite direction. By adjusting the relative position of the lamp fixture 140, the light emitted by light source 155 may be aimed at a particular area or illumination target. Some embodiments of the present invention further allow for the adjustment of the light source 155 with respect to a pan axis, as will be described in further detail below.

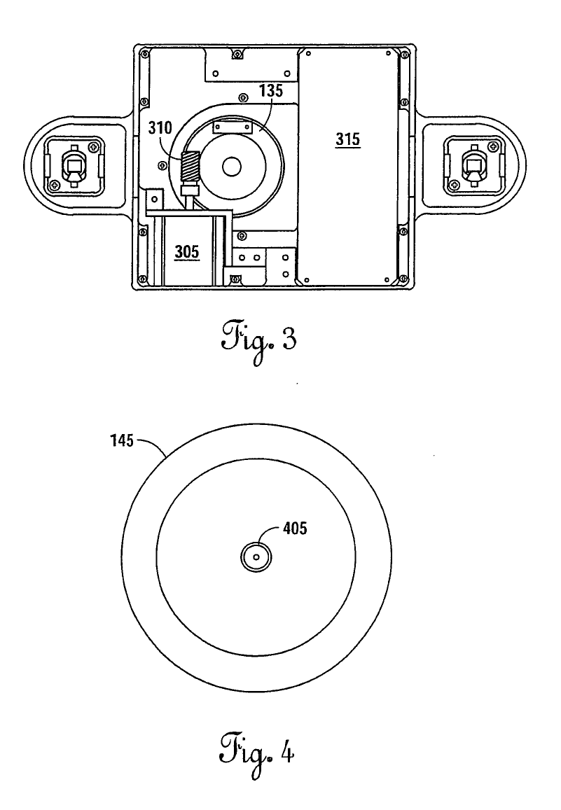

Referring now to FIG. 3, which depicts a top view of the main housing 120 portion of track head 115 (with the outer cover removed), according to one embodiment of the present invention. Depicted are a pan axis drive motor 305, a pan axis worm drive 310 and a drive electronics enclosure 315. In preferred embodiments, the pan axis drive motor 305 is mechanically cooperated with the pan axis worm drive 310 such that rotation of the pan axis drive motor 305 will cause a corresponding rotation in the pan axis worm drive 310. The pan axis worm drive 310 is further mechanically cooperated with an upper portion of the mechanical arm 135 that is attached at its lower portion to the lamp fixture 140 (see FIGS. 1A and 1B).

In some preferred embodiments, the rotation of pan axis worm drive 310 by the pan axis drive motor 305 will cause a rotation of the mechanical arm 135 about a pan axis. For example, in one embodiment a user may initialize the pan axis drive motor 305 causing rotation in the mechanical arm 135 and subsequently causing the rotation the lamp fixture 140 and bulb housing 145 about a pan axis. In one embodiment, the pan axis drive motor may cause rotation of the mechanical arm such that the light source 155 may be positioned along a 360 degree rotation around the pan axis. In some embodiments a user may initialize the pan axis drive motor 305 alone or in conjunction with the tilt axis drive motor to aim the light source 155 at a desired target of illumination. As will be described in further detail below, in some embodiments one or more tilt axis drive motors and/or pan axis drive motors may be electrically connected to a control circuit in the drive electronics enclosure 315 for controlling the position/orientation of light source 155.

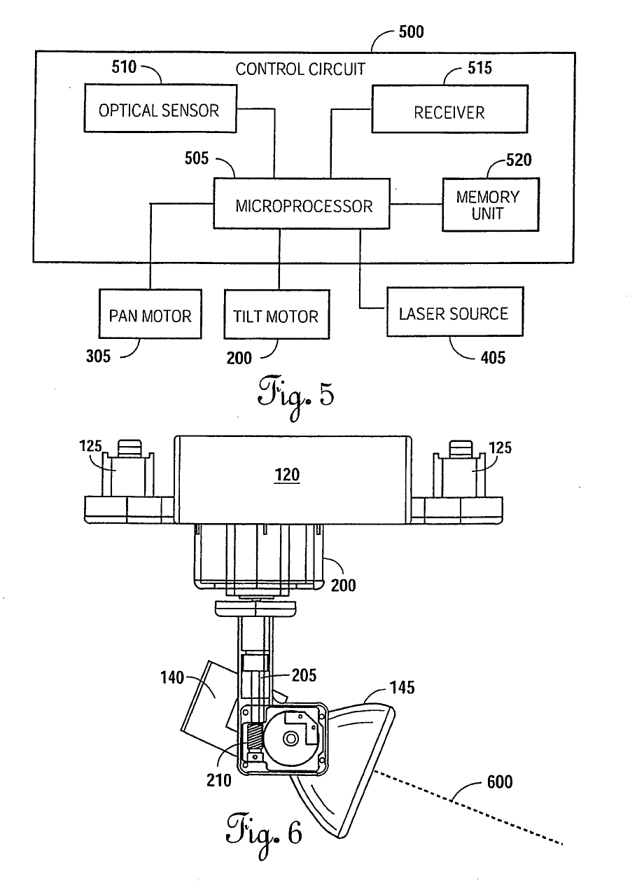

Turning now to FIG. 4, which depicts a front view of bulb housing 145 together with a laser source 405 disposed within. The laser source 405 may comprise essentially any coherent light source; however, in preferred embodiments the laser source 405 will comprise a colored laser. In some embodiments the laser source 405 is mechanically cooperated with the bulb housing 145 and/or lamp fixture 140 such that movement of the bulb housing 145 and/or lamp fixture 140 will translate into a corresponding movement of the laser source 405. However, in alternative embodiments the laser source 405 may be disposed in any location wherein the emitted beam is parallel with the direction of light emitted by light source 155, such that the laser source may visibly signal an orientation of the light source 155. In preferred embodiments, the laser source 405 and light source 155 will be fixed in substantially the same orientation such that the light emitted by laser source 405 and the light source 155 will be emitted in substantially the same direction. By way of example, the laser source 405 may be used together with the light source 155 to facilitate a user in directing the light emitted by light source 155 at a particular illumination target. Additionally, a user may initialize both the light source 155 and laser source 405 to aid in positioning the track head 115. Alternatively, a user may initialize either the light source 155 or laser source 405, at the exclusion of the other. As will be described in further detail below, initialization of the light source 155 and/or laser source 405 may be accomplished either manually, or automatically controlled via a control circuit.

FIG. 5 depicts a block diagram of an exemplary control circuit 500 according to one embodiment of the present invention. The control circuit 500 may comprise a microprocessor 505 that is electrically coupled to an optical sensor 510, a receiver 515 and a memory unit 520. In some embodiments, the control circuit will be further electrically coupled to the tilt motor 200, the pan motor 305 and the laser source 405 as discussed above. The receiver 515 may be configured to receive commands from essentially any optical or RF source and/or any wired means. By way of example, the receiver 515 may be adapted to receive infra-red (IR), RF, Bluetooth or ZigBee® wireless signals etc. Additionally, the receiver 515 may be configured to receive wired signals via a wired source, for example, using power line communications. However, in at least one preferred embodiment, the receiver 515 is configured to receive signals via Infra Red link.

The control circuit 500 can be used to control the manual positioning of the light source 155 through initialization of one or more tilt motors and/or pan motors. Specifically, positioning about the tilt axis may be affected by initialization of one or more tilt motors; likewise, positioning about the pan axis may be controlled through the initialization of one or more pan motors. In some preferred embodiments, due to the large frictional force imposed by the tilt axis worm gear 210 and pan axis worm drive 310, once the tilt and/or pan motor is no longer powered up, the movement of light source 155 will automatically stop.

By way of example, a user wanting to adjust the tilt and/or pan orientation of the track head 115 may send commands to be received by the receiver 515 of the control circuit 500. Upon receipt of remote signaling by the user, one or more motors disposed in the track head 15 can be initialized to rotate the light source 155 in order to focus the light on a desired target of illumination. For example, in response to received IR signals, the microprocessor 505 can cause the actuation of one or both of the tilt motor 200 and/or pan motor 305 to alter the orientation of light source 155. The remote control of tilt motor 200 and pan motor 305 will enable a user to remotely aim the light source 155 at a desired target of illumination without the need for manually adjusting the track head 115.

In some scenarios, the user's positioning of the light source 155 may be aided by use of a laser guide indicating the direction of light emanating from the bulb housing 145. For example, to aid in positioning the light source 155 a user may send remote signaling to receiver 515 to cause initialization of the laser source 405 disposed in bulb housing 145. Once initialized (i.e., turned “on”), the laser source 405 will project a laser beam along the direction corresponding to the direction of light projected from light source 155. In this manner, a user may use light source 405 as a guide for use in positioning light source 155.

In one embodiment, the positioning of light source 155 may occur in response to the loading of position or coordinate information stored in memory unit 520. For example, the receiver 515 of control circuit 500 may receive position information indicating a position/orientation of track head 115. Position and orientation information is then stored in memory unit 520 and may later read by microprocessor 505 for use in positioning light source 155 upon request of the user. For example, track head coordinate data stored in memory unit 520 could be automatically read when power is first delivered to the track head 115 (i.e., when the unit is placed into a power ‘on’ state).

In another embodiment, position information could be retrieved from the memory unit 520 upon receipt of a remote command from the user by receiver 515. For example, position information could be stored as “setting” or “option data.” Upon selection by a user, via remote signaling, the microprocessor 505 will read track-head position setting information from memory unit 520 and position the track head 115 accordingly.

In yet another embodiment, positioning of the track head 115 may occur automatically in response to the detection of backscatter illumination by optical sensor 510. For example, as will be discussed in further detail below, optical sensor 510 may receive backscatter illumination resulting from light source 155 and in response, the track head 115 may be repositioned such that the light source 155 is placed in a new different orientation. In another embodiment, the optical sensor 510 may detect backscatter illumination resulting from light emitted by laser source 405 and may rotate the orientation of light source 155 until an optimal position is determined. For example, optical sensor 510 may be used to detect the backscatter illumination from one or more objects that may be used as illumination targets. In one preferred embodiment, a reflective surface, such as a sticker, may be used to direct backscatter illumination toward optical sensor 510. By detecting an object such as a sticker, the optical sensor 510 may locate the target of illumination and may position the light source 155 accordingly.

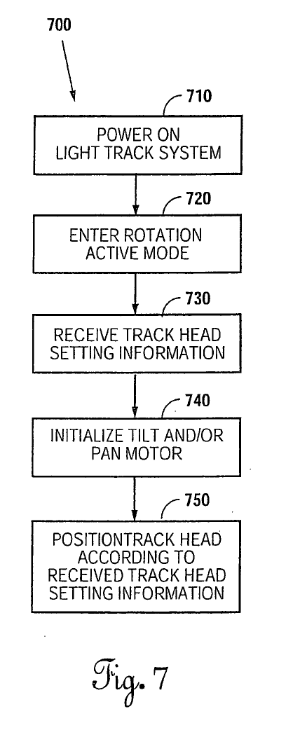

FIG. 6 illustrates the track head 115 according to one preferred embodiment of the present invention. Shown are main housing 120, track contactors 125, lamp fixture 140, bulb housing 145, tilt axis drive motor 200, tilt axis drive shaft 205, tilt axis worm track head 115.

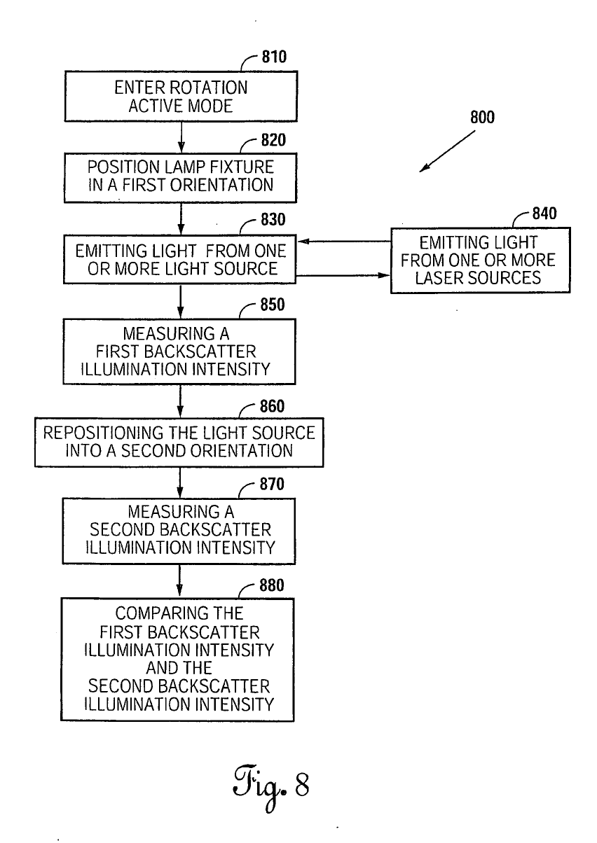

FIG. 7 is a flow diagram that shows the operations performed in another embodiment of the invention, wherein the track head 115 orientation and position settings are retrieved from the memory unit 520 of control circuit 500. In the first operation, represented by the flow diagram box numbered 710, the track light system 100 is powered on. In the next operation, represented by flow diagram box numbered 720, the track head 115 is placed in rotation active mode. This operation can automatically occur upon initialization of the track head 115, or may also occur in response to signaling by the user.

In the next operation, represented by the flow diagram box numbered 730, the microprocessor 505 will retrieve position/orientation settings from the memory unit 520 of control circuit 500. The position/orientation settings information may comprise position and or light intensity information for one or more track heads used to adjust the position and/or intensity of the light source.

In the next operation, represented by the flow diagram box numbered 740, the microprocessor 505 causes the initialization of the tilt motor 200 and/or pan motor 305. Actuation of the motors is caused in response to the retrieved position/orientation setting information and will commence until the respective motors have been positioned according to the desired position/orientation settings.

FIG. 8 is a flow diagram that illustrates the steps performed in automatically positioning the track light system 110 with reference to a measurement of backscatter illumination, according to one embodiment of the invention. The method begins in step 810 in which the track head 115 is placed in a rotation active mode. Entry into the rotation active mode can be initiated manually by a user via remote signaling, or may occur automatically upon powering on the track head 115.

In step 820 the track head 115 positions the lamp fixture 140 in a first orientation such that the corresponding light source 155 and laser source 405 are also situated in a first orientation. This initial positioning of track head 115 may also occur as the result of default position/orientation information retrieved from the memory unit 520 or may occur in response to remote signaling by the user.

In step 830, the light source 155 is initialized causing illumination to be emitted in a direction corresponding to the initial positioning of track head 115. Initialization of the light source 155 may comprise illuminating one or more light bulbs or LED lamps. By way of example, the initialization of light source 155 may include the initialization of one or more LED type PAR-30 lamps.

In alternative step 840, one or more laser source 405 may be initialized in place of the initialization of light source 155 in step 830. Initialization of laser source 405 will result in laser beam 600 being emitted from the bulb housing 145, projecting a bright spot on the illumination target.

In step 850, a first backscatter illumination intensity will be measured. By way of example, light reflected from the light source 155 and/or laser source 405 (as discussed above with respect to steps 830 and 840), will be measured by the optical sensor 510 of control circuit 500. The backscatter illumination received by the optical sensor 510 may be reflected by virtually any object or surface; however, in one preferred embodiment, the backscatter illumination will be reflected by a sticker that is placed on the desired illumination target.

In step 860, the lamp fixture 140 is positioned in a second orientation such that the corresponding light source 155 and laser source 405 are also situated in the second orientation. Because the emitted light from light source 155 and/or laser source 405 will have shifted from that of the first orientation, the backscatter illumination received by optical sensor 510, originating from those sources will also have changed.

In step 870, the backscatter illumination intensity at the second orientation will be measured. Then in step 880, the control circuit 500 will make a comparison between the backscatter illumination intensity measured at the first orientation and that measured at the second. In preferred embodiments of the invention, a greater intensity of backscatter illumination will correlate with a more direct application of light onto an illumination target. In some embodiments, the user may aid in the automatic tracking of an illumination target by increasing the amount of backscatter illumination produced by light reflected by the target. For example, a user may wish the track head 115 to be positioned such that the light source 155 is directed toward a display case. As such, the user may place a stick on the display case such that the sticker will return a greater amount of backscatter illumination to the optical sensor 510 when the light is correctly positioned. Thus, when operated in rotation active mode according to the above example, the track head 115 will automatically rotate the lamp fixture into an orientation that delivers optimal light levels to the illumination target.

FIG. 9 depicts a block diagram of a hand unit circuit 900 according to one embodiment of the present invention. The hand unit circuit 900 comprises a microprocessor 910, an input circuit 920, a memory 930 and a transmitter circuit 940. In one preferred embodiment, the input 920 circuit, memory 930 and transmitter circuit 940 are all electrically communicated with microprocessor 910.

In preferred embodiments of the invention, the hand unit circuit 900 will be cooperated in a handheld control module (not shown) for use in remotely communicating with, and controlling the positioning of, one or more track heads 115. For example, in one embodiment of the invention, the hand unit circuit 900 may be connected to an external source such as another processor based device (e.g. a computer) or the internet etc., via input circuit 920. After being connected to the external source, the hand unit circuit 900 may receive track head position setting information for one or more track heads within a defined space. For example, the handheld control module may be directly connected to the internet via the input circuit 920 and may receive track head position settings for multiple track heads installed in a given retail establishment. In one preferred embodiment, the track head position settings will be numerically indexed such that corresponding settings can be correlated with a specific track head. However, in alternative embodiments, virtually any addressing scheme may be used to correlate track head position settings with one or more corresponding track heads.

In preferred embodiments, the track head position settings received by input circuit 920 will be stored in the memory 930 and then transmitted to the control circuits 500 of one or more track heads 115, via the transmitter circuit 940. In one preferred embodiment, the transmitter circuit 940 will transmit track head position settings via Infra Red link; however, virtually any optical or radio frequency (RF) transmission method may be known. For example, the transmitter circuit 940 may transmit via RF, Bluetooth or ZigBee® wireless signals.

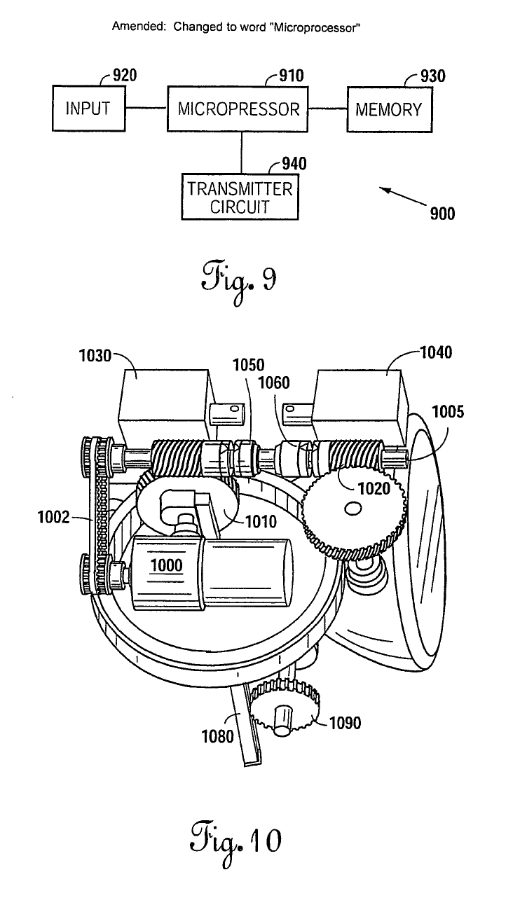

In some embodiments of the present invention, track head positioning may be accomplished with the use of a single motor for positioning the track head with respect to the pan and tilt axes, rather than using both the pan motor 305 (for positioning along the pan axis) and the tilt motor 200 (for positioning along the tilt axis). FIG. 10 illustrates one preferred embodiment of a single motor drive mechanism for use in carrying out a single motor implementation of the present invention. Specifically, FIG. 10 depicts an axis drive motor 1000, a double shaft drive belt 1002, a double shaft 1005, a tilt axis drive worm gear set 1010, a pan axis drive worm gear set 1020, a tilt axis engage solenoid 1030, a pan axis engage solenoid 1040, a tilt axis dog clutch 1050, a pan axis dog clutch 1060, a pan axis drive pulley set 1070, a tilt adjust rack 1080 and a tilt adjust rack gear 1090.

As depicted in FIG. 10, the axis drive motor 1000 is mechanically cooperated with the double shaft 1005 via the double shaft drive belt 1002. The double shaft is further mechanically cooperated with the tilt axis dog clutch 1050 and the pan axis dog clutch 1060. Both of the tilt axis dog clutch 1050 and the pan axis dog clutch 1060 are further mechanically coupled to the tilt axis engage solenoid 1030 and the pan axis engage solenoid 1040, respectively (the mechanical connection between the solenoids and the appropriate clutches are not shown). As can be seen by the toothed shape of the dog clutch portions depicted in FIG. 10, the tilt axis dog clutch 1050 is configured to mechanically engage the tilt axis drive worm gear set 1010. The tilt axis worm gear set 1010 is mechanically engaged to the tilt adjust rack 1080, which is in turn coupled to the tilt adjust rack gear 1090. Similarly, the pan axis dog clutch 1060 is configured for mechanical engagement with the pan axis drive worm gear set 1020. The pan axis drive worm gear set 1020 is further coupled to the pan axis drive pulley set 1070. Although the drive belt for the pan axis drive pulley set 1070 is not illustrated, the drive belt may be of substantially any design depending on torque requirements. By way of example, the drive belt could comprise a toothed belt design or a v-belt design, depending on implementation. Furthermore, although the tilt and pan axis dog clutch portions (1050 and 1060) may be of a toothed design as depicted in FIG. 10, essentially any suitable mechanical coupling mechanism may be used. For example, the tilt and pan axis dog clutch portions (1050 and 1060) may be a of a cone clutch design using friction material.

As can be seen in FIG. 11, which depicts a top view of the single motor drive mechanism according to some embodiments, the tilt axis dog clutch 1050 and the pan axis dog clutch 1060 are not in engagement with the tilt or pan axis drive worm gear sets (1010 and 1020). In practice, actuation of the axis drive motor 1000 will induce a rotation in the double shaft drive belt 1002, which will translate into a corresponding rotation in the double shaft 1005. Rotation of the double shaft 1005 causes a similar rotation of the tilt axis dog clutch 1050 and the pan axis dog clutch 1060; however, rotation of the dog clutch portions will have no corresponding effect on either of the tilt axis drive worm gear set 1010 or the pan axis drive worm gear set 1020, without mechanical engagement therewith.

In preferred embodiments of the invention, a user may position the track light head with respect to the pan and tilt axes by actuating one of the tilt axis engage solenoid 1030 or the pan axis engage solenoid 1040, together with the axis drive motor 1000. Specifically, each of the tilt axis engage solenoid 1030 and the pan axis engage solenoid 1040 is configured to induce movement in the respective dog clutch portions in order to cause mechanical engagement between one of the dog clutch portions and the respective tilt axis drive worm gear set 1010 or the pan axis drive worm gear set 1020. By way of example, a user may adjust the track head 115 about the tilt axis by first actuating the tilt axis engage solenoid 1030, causing a mechanical coupling between the tilt axis dog clutch 1050 and the tilt axis drive worm gear set 1010. When the axis drive motor is initialized, rotation of the tilt axis drive worm gear set 1010 will cause movement of the tilt adjust rack 1080 in either an upward or downward motion. As the tilt adjust rack 1080 is moved, it causes rotation in the tilt adjust rack hear 1090. Because the tilt control gear is mated with the shaft to which the bulb housing 145 is attached, rotation of the tilt adjust rack gear 1090 affects the corresponding tilt position of the track head 115.

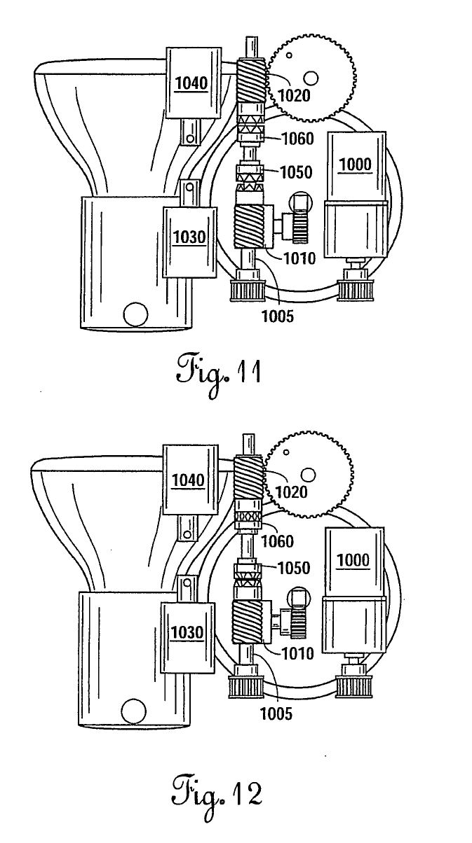

FIG. 12 illustrates one embodiment of the present invention, wherein actuation of the pan axis engage solenoid causes a coupling between the pan axis dog clutch 1060 and the pan axis drive worm gear set 1020. By way of example, in the configuration of FIG. 12, initialization of the axis drive motor 1000 will induce a corresponding rotation in the double shaft 1005. Because the pan axis dog clutch 1060 is engaged with the pan axis drive worm gear set 1020, rotation of the axis drive motor 1000 will translate into a corresponding rotation in the pan axis drive worm gear set 1020. When the pan worm gear set 1020 is engaged, it drives the pan axis drive pulley set 1070 (see FIG. 10) to rotate the pan position of the track head 115. Thus, through actuation of the pan axis engage solenoid 1040 and axis drive motor 1000, a user may control the pan axis positioning of the track head 115.

In other aspects, a remote control and laser light is used to transmit data from the remote control device to the track head. The remote control device contains a laser source that emits visible light, for instance, in a dot format. Alternatively, any other transmitter emitting any other type of signal (e.g., any wireless signal or any type of electrical signal) may be used. By dot format, it is meant that a sequence of laser dots appears at the receiver representing information. When the laser light (e.g., in dot format) reaches a detector area on the track head, it activates the track head into a mode of operation for aiming and dimming. The remote control device also includes an IR or RF emitter (or any other type of emitter of any other type of signal) that will transmit digital signals/data to the track head for the actual aiming and dimming functions. After these functions have been completed, the remote control device the laser dot light is sent to the track head detector to deactivate it from the aiming/dimming mode. After deactivation, the track head is activated and deactivated by a wall switch.

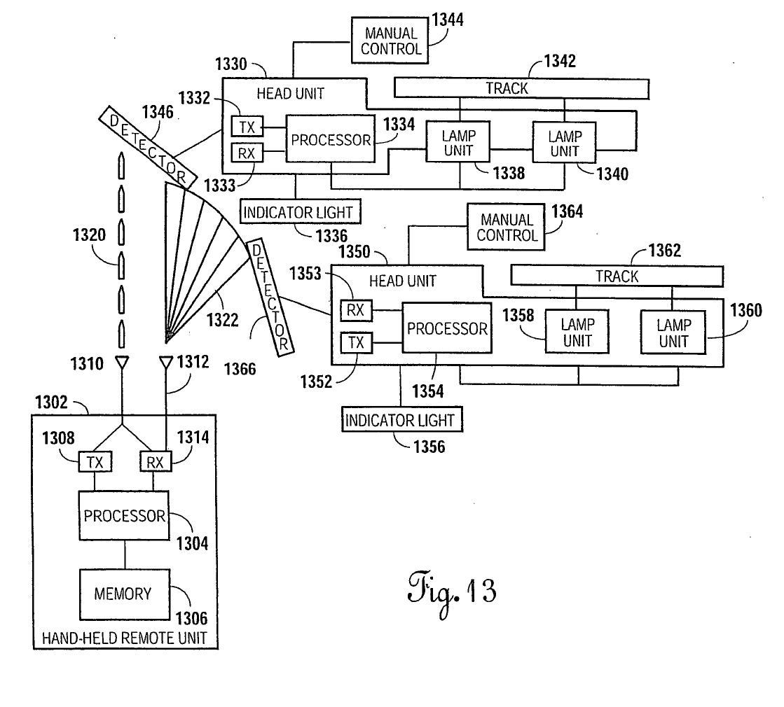

Referring now to FIG. 13, one example of a track lighting that uses a remote unit is described. A remote control unit 1302 includes a processor 1304, a memory 1306, a transmitter 1308, a first antenna 1310, a second antenna 1312, and a receiver 1314. The processor 1304 is any type of processing device such as a microprocessor. The memory 1306 is any type of memory structure (e.g., RAM, ROM, or the like) that can store information or computer executable instructions. The transmitter 1308 includes appropriate circuitry/programmed software for transmitting information from the remote control unit 1302 while the receiver 1314 includes appropriate circuitry/programmed software for receiving information transmitted to the remote control unit 1302.

The remote control unit 1302 transmits a direct laser signal 1320 from the first antenna 1310 and/or a wider angle RF/IF signal from the second antenna 1312. Alternatively, a single antenna may be used to transmit both types of signals.

A first head unit 1330 includes a transmitter interface 1332, a receiver interface 1333, and a processor 1334. An indicator light 1336 is coupled to the unit 1330. The head unit 1330 also includes first and second lamp units 1338 and 1340 and the head unit 1330 is positioned along a track 1342. The processor 1334 is coupled to the first lamp unit 1338 and the second lamp unit 1340. A manual control unit 1344 can be used to activate or deactivate the head unit 1330. A detector 1346 is used to receive signals from the remote control unit 1302.

A second head unit 1350 includes a transmitter interface 1352, a receiver interface 1353, and a processor 1354. An indicator light 1356 is coupled to the unit 1350. The head unit 1350 also includes third and fourth lamp units 1358 and 1360 and the head unit 1350 is positioned along a track 1362. The processor 1354 is coupled to a third lamp unit 1358 and a fourth lamp unit 1360. A manual control unit 1364 can be used to activate or deactivate the head unit 1350. A detector 1366 is used to receive signals from the remote control unit 1302.

The transmitter interfaces 1332 and 1352 are any type of transmitter circuitry configured to transmit signals from their respective head units. The receiver interfaces 1333 and 1353 are any type of receiver circuits, sensors, and or antennas that are configured to receive signals (of any type) from the remote control 1302 or other exterior sources. The processors 1334 and 1354 are any type of processing devices such as microprocessors or the like. In one aspect, these devices are programmed to control movement of the various lamp units. The indicator lights 1336 and 1356 are any type of lighting device that can be used to show the mode of operation of head units. The lamp units 1338, 1340, 1358, and 1360 are lamp units as described elsewhere herein having one or more motors that adjust the position of a lamp within these units. The tracks 1342 and 1362 are mechanical tracks as described elsewhere herein to which the lamp units are coupled and can move. The manual control units 1344 and 1364 can be wall switches in one example. The detectors 1346 and 1366 are any type of sensing arrangement that are configured to receive IF or RF signals.

In one example of the operation of the system of FIG. 13, laser light 1320 (e.g., in dot format) from the remote control unit 1302 reaches a detector area 1346 on the track head 1330, and it will activate the track head 1330 into a mode for aiming and dimming. In one aspect, the remote control device also includes an IR or RF transmitter that will transmit digital signals/data 1322 to the track head 1330 for the actual aiming and dimming functions. These signals may include information indicating the location of the target object. Alternative, these signals and information may be omitted and as described elsewhere herein the head unit may automatically (without manual intervention) locate and aim it lighting sources/devices at the target object. After these functions have been completed, the remote control device 1302 (via user interaction or initiation) transmits laser dot light 1320 to the track head detector 1346 to deactivate it from the aiming/dimming mode. In another aspect and after deactivation, the track head 1302 is activated and deactivated by the manual control 1344.

In one approach, the laser emits light 1320 in one aspect is an extremely focused narrow beam angle so that it activates only one track head 1330 or 1350 at a time. By “extremely focused” it is meant that control beams are isolated from each other. The IR/RF emits light 1322 is a wide beam angle, for example, an angle of up to approximately 170 degrees. If multiple track heads 1330 and 1350 are activated at the same time, the IR/RF signal can reach to all of them for turning the lights on and off, and dimming.

The detector areas 1346 and 1366 on the track heads 1330 and 1350 can detect both laser signals 1320 and IR/RF signals 1322. In one aspect, when laser light 1320 is received, the detector area 1346 or 1366 will light up in one example in a continuous (solid) pattern (via the lights 1336 and 1356) to indicate track head is in remote control mode. In another aspect when the IR/RF signals 1322 are sent from remote control unit 1302, the same detector area receives the signals and the light 1336 or 1356) will be blinking to confirm/indicate it is receiving the signals and processing the data transmitted.

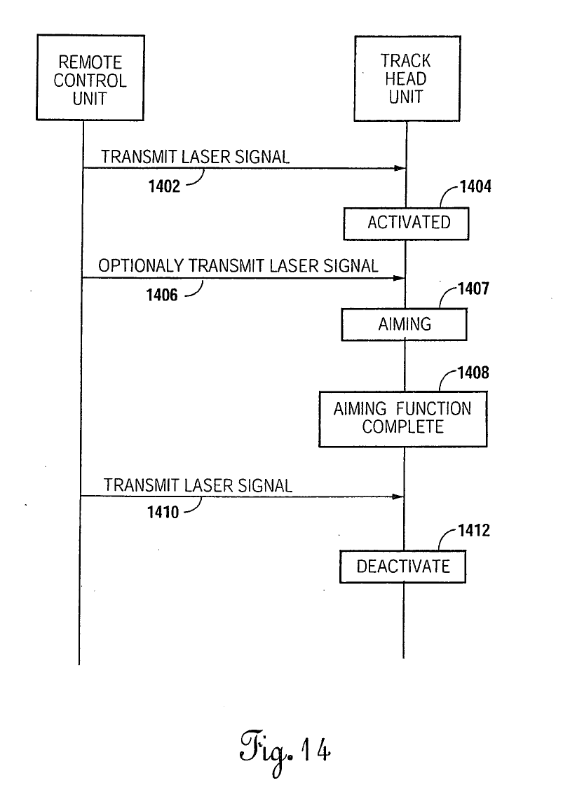

Referring now to FIG. 14, one example of the interaction between a remote control unit and track head unit is described. In this example, the track head can include receiver for receiving signals from a remote unit, lamp units for illuminating a target object, control boards, and motors for adjusting the lamp units.

At step 1402, the remote unit transmits a focused laser beam to the track head unit. In one aspect, this is user initiated where a user aims and manually shoots the laser beam to the track head unit.

At step 1404, the track head unit is activated and enters aiming mode. At step 1406, the remote unit may transmit data signals that will help the track head unit aim one of its lamps at a target.

At step 1407, the aiming function is undertaken. In one example, these signals include information that indicates the coordinates of the target object to be illuminated.

Alternatively and in still other aspects, the track head unit is able to automatically detect a defined illumination target (without receiving coordinate information from the remote unit), and automatically aim its light to this target without the use of data signals from the remote unit. In one example, a non-powered locator on illumination target is positioned on the target and located by the track head unit. For instance, a non-powered device is placed on an illumination target (e.g., sticker with defined graphics, paint, texture, barcode, and so forth). The track head unit is equipped with a detector which can detect and position the above locator (e.g., camera, optical sensor, optical scanner with laser or IR light to mention a few examples). Once a detector at the track head unit locates the illumination target via its locator, the track head unit will automatically adjust one or more of its lamps to aim its light directly to the locator, and hence the illumination target.

In other aspects, a battery powered locator on illumination target is used as the locator and no data is received from the remote unit. For instance, a battery-powered locator device is placed on an illumination target (e.g., a device emitting visible, IR, or RF, or Bluetooth, or other types of light signals). In this arrangement, the track head unit is equipped with a detector which can receive the light signals from above locator (e.g., the locator can be camera, optical sensing receiver/detector, optical sensing scanner with laser or IR light to mention a few examples). Once the detector at the track head unit locates the illumination target via the locator at the target, the track head unit aims its light directly to the locator, and hence the target will be illuminated.

In another aspect, a battery powered locator is used that emits IR light on illumination target, and a visible or IR laser scanner on track head acts as position detector. In one aspect, a laser scanner is built into or incorporated with the lamps. In one example, the lamps are one or more LEDs and this arrangement is referred to herein as “an LED engine”. In this case, the scanner may include two laser sources: one that emits a line of light in a horizontal axis, and the other that emits a line of light in a vertical axis. This arrangement enables two-axis scanning of the illuminated targets to position the locator on illumination target.

At step 1408, the aiming functions are complete (i.e., the lamps have been aimed at the target). In one aspect, the user may observe that this is complete by seeing that the object is illuminated. In another aspect, the head unit may determine that it has successfully found the object and may indicate this to the user holding the remote (e.g., by flashing a light in one example). In still another aspect, the head unit may transmit a signal to the remote that it has been successful and that aiming has been completed.

At step 1410, a laser signal is transmitted from the remote to the head unit. At step 1412, the head unit is deactivated. The user may in one example see that the target is illuminated and thus initiate the sending the deactivation signal.

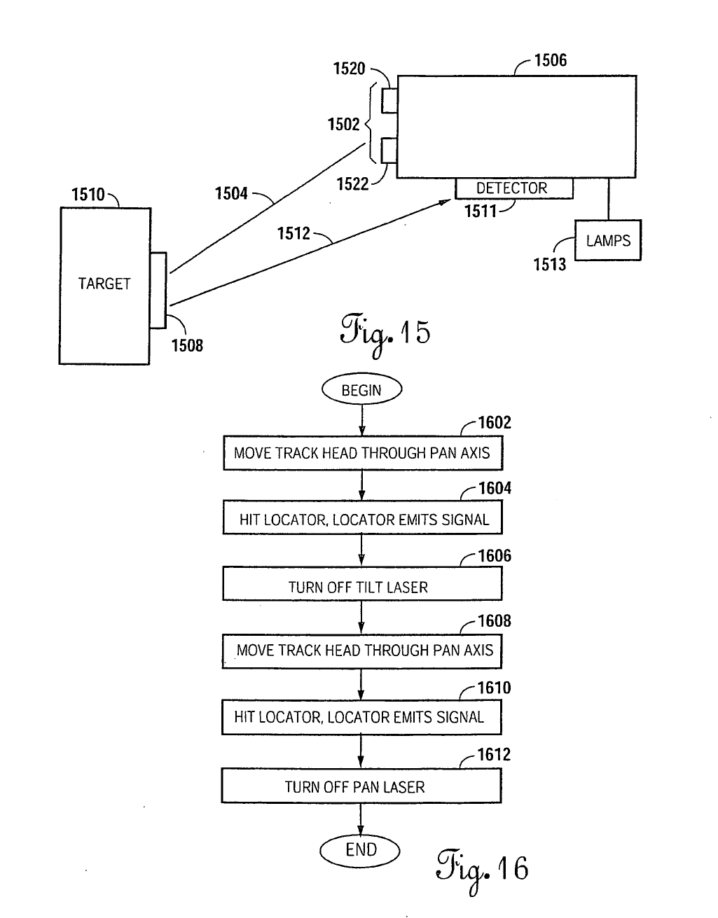

Referring now to FIG. 15, one example of an active indicator is described. A vertical and horizontal laser light emitter 1502 (including a pan axis laser 1520 and a tilt axis laser 1522) emits a laser line 1504 from a track head unit 1506. A detector 1511 detects the target 1510 (or signals from the target 1510). Lamps 1513 illuminate the target once the target is found. Although the detector 1511, laser emitter 1502, and lamps 1513 are shown as being separated, it will be appreciated that they may be disposed together in close proximity as well.

The lasers 1520 and 1522 of the track head unit 1506 are adjusted along one axis at a time in order to locate (and thereby illuminate) a target. In this respect and depending on how the lamps are configured with the track head, the entire track head (including the lamps) might be moved while in other instances only the lamp portion of the track head is used.

In one aspect, the lasers of the track head 1506 may first be moved through the pan axis such that the pan axis laser line passes over an area, for instance, across the area of a room. When the laser line 1504 strikes a locator 1508 on the target object 1510, the locator 1508 will emit a signal 1512 indicating that the track head 1506 is optimally positioned relative to the pan axis and this is received at the detector 1511. The pan axis laser 1520 will then be turned off and the tilt axis laser 1522 will be used to repeat the process for the tilt axis so that the lamps 1513 of the target head unit 1506 are adjusted to locate a target. Once the target is located, it can be illuminated by lamps 1513 (since its location is now known).

Referring now to FIG. 16, one example of an approach for operating the system of FIG. 15 is described. At step 1602, laser light emitter 1502 of the track head 1506 may first be moved through the pan axis such that the pan axis laser line 1504 passes over an area such as the area of a room. At step 1604, when the laser line 1504 strikes a locator 1508 on the target object 1510, the locator 1508 will emit a signal 1512 indicating that the track head 1506 is optimally positioned relative to the pan axis. At step 1606, the pan axis laser 1520 will then be turned off.

At step 1608, the tilt axis laser 1522 is moved to pass through the area, for instance the area of a room. At step 1610, when the laser line 1504 strikes a locator 1508 on the target object 1510, the locator 1508 will emit a signal 1512 indicating that the track head 1506 is optimally positioned relative to the tilt axis. At step 1612, the tilt axis laser 1522 will then be turned off. The object is now located and can be illuminated.

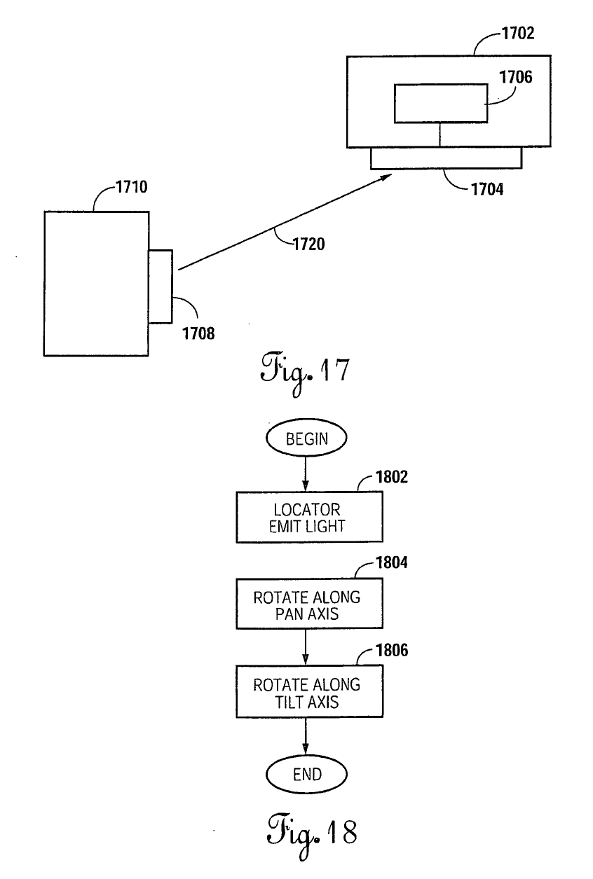

Referring now to FIG. 17, an example where s locator 1708 may emit a visible light to indicate the location of the illumination target is described. A track head 1702 is equipped with a photo-sensitive device 1704 and a microcontroller 1706 for determining the location of light 1720 emitted by the locator 1708 positioned at the target 1710. The microcontroller 1706 is used to first rotate the track head 1702 along either the pan/tilt axis to the optimal location. The rotation process will then be repeated for the remaining axis.

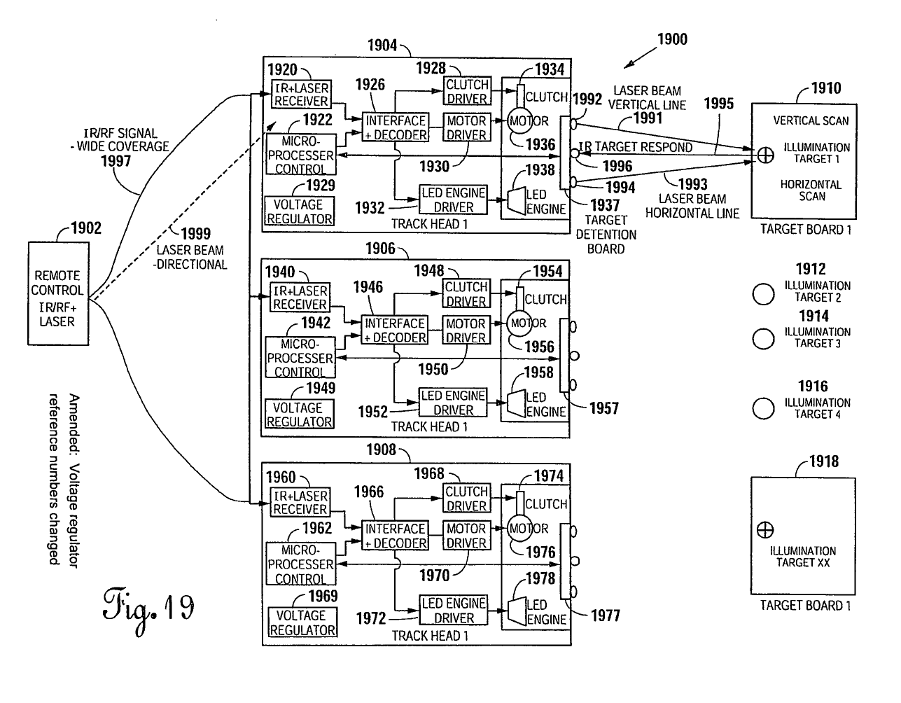

Referring now to FIG. 18, one example of an approach for operating the system of FIG. 17 is described. At step 1802, the locator device 1708 emits light 1720 that is received at the photo sensitive device 1704. At step 1804, the track head 1710 is rotated along the pan axis to the optimal location. At step 1806, the track head 1710 is rotated along the tilt axis to the optimal location. The target object is now located and can be illuminated.

Referring now to FIG. 19, one example of a lighting system 1900 that uses a remote control unit is described. The lighting system 1900 includes a remote control 1902, a first track head 1904, a second track head 1906, and a third track head 1908. The track heads 1904, 1906, and 1908 communicate with the remote control unit 1902 and also one or more of a first illumination target 1910, a second illumination target 1912, a third illumination target 1914, a fourth illumination target 1916, up to an xth illumination target 1918.

Each of the track heads 1904, 1906, and 1908 include an infrared and laser receiver (1920, 1940, 1960), a microprocessor controller (1922, 1942, 1962), a voltage regulator (1924, 1944, 1964), an interface decoder (1926, 1946, 1966), a clutch driver (1928, 1948, 1968), a motor driver (1930, 1950, 1970), a LED engine driver (1932, 1952, 1972) a clutch (1934, 1954, 1974), a motor (1936, 1956, 1976), an LED engine (1938, 1958, 1978), a target detection board (1937, 1957, 1977) that includes lighting sources and sensors.

The remote control 1902 in one example is a hand held unit that emits laser or IR beams as has been described above. The first track head 1904, the second track head 1906, and the third track head 1908 include various components as described herein to control the locating of a target and the aiming of lamps at the target. The first illumination target 1910, second illumination target 1912, third illumination target 1914, and fourth illumination target 1916 are any target object that is to be illuminated.

As for the components of the track heads 1904, 1906, and 1908, the infrared and laser receiver (1920, 1940, 1960) are any sensing arrangement that receives laser and/or IR radiation from a remote control. The microprocessor controller (1922, 1942, 1962) is any type of processing device. The voltage regulator (1924, 1944, 1964) provides for voltage regulation of the components of the track heads. The function of the interface decoder (1926, 1946, 1966) is process the incoming signal and send out to the appropriate device. The function of the clutch driver (1928, 1948, 1968) is engage the motor to conduct appropriate movement (pan or tilt). The function of the motor driver (1930, 1950, 1970) is to make the motor move clockwise or counterclockwise. The function of the LED engine driver (1932, 1952, 1972) is turn on the lamp and control the dimmer by pulse width modulation (PWM). The clutch (1934, 1954, 1974) provides a mechanical connection and coupling between the motor and the gears of a particular gearing structure that rotates the lamps in a particular direction. The motor (1936, 1956, 1976) may be a single motor as described herein that alternatively engages one of two gearings structures to rotate the lamps in a particular direction. The LED engine (1938, 1958, 1978) includes lamps to illuminate the target. The target detection board (1937, 1957, 1977) includes lighting sources and sensors to illuminate and locate targets.

In one example of the operation of the system of FIG. 19, the remote unit transmits 1902 a focused laser beam 1999 to the track head unit 1904, 1906 or 1908. In another example, an IR beam 1997 is transmitted to all of the head units. The receiver receives the beam and the interface and decoder determines if the beam or the information included in the beam are sufficient to activate the unit. If it is, the microprocessor control cause the track head unit to enter aiming mode.

The remote unit 1902 may transmit data signals that will help the track head unit aim one of its lamps at a target. In one example, these signals include information that indicates the coordinates of the target object to be illuminated. In still other aspects, the track head unit is able to automatically detect a defined illumination target (without receiving coordinate information from the remote unit), and automatically aim its light to this target. In one example, a non-powered locator on illumination target is used. For instance, a non-powered device is placed on an illumination target (e.g., sticker with defined graphics, paint, texture, barcode, and so forth). In other examples, a powered locator may be used.

As shown in FIG. 19, a vertical light emitter 1992 and horizontal laser light emitter 1994 emit a laser lines 1991 and 1993 from a track head unit. The light emitters 1992 and 1994 of the track head unit is adjusted along one axis at a time in order to locate (and thereby illuminate) a target. For example, the track head may first be moved through the pan axis such that the pan axis laser line passes over an area in a room. When the laser line 1991 strikes a locator on the target object, the locator will emit a signal 1995 indicating that the track head is optimally positioned relative to the pan axis and this is received at a detector 1996. The pan axis laser 1992 will then be turned off and the tilt axis laser 1994 will be used to repeat the process for the tilt axis so that the lamps of the target head unit are adjusted to locate the target. Once the target is located in can be illuminated by the lights or lamps of the LED engine 1938 (since its location is now known).

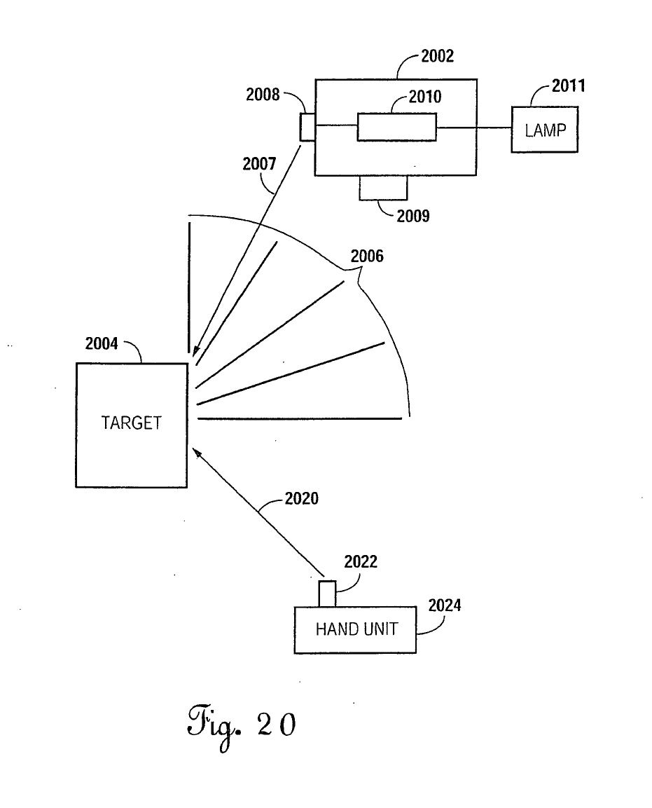

Referring now to FIG. 20, one example of a passive aiming approach is described. First, a track head 2002 may be properly aimed at an illumination target 2004 by detecting backscatter radiation 2006 emitted by the target 2004. In one aspect, light 2007 from a light source 2008 may be emitted from a location on (or proximate to) the track head 2002 such that backscatter light 2006 reflected from the illumination target 2004 may then be detected by a detector 2009. Based on the location of the detected backscatter light, a microcontroller 2010 will then be used to properly position the track head 2002 and/or lamp 2011 with respect to the pan and tilt axes. In one aspect, the passive illumination target 2004 may include one or more retro-reflectors (which reflect light in a direction opposite but parallel to that of the incident beam).

In another aspect, the illumination target 2004 may be illuminated by an incident laser light 2020 emitted from a laser 2022 on a hand unit 2024. The light 2020 “paints” the target 2004 and this can be detected by the head unit 2002 and the lamps focused on the target.

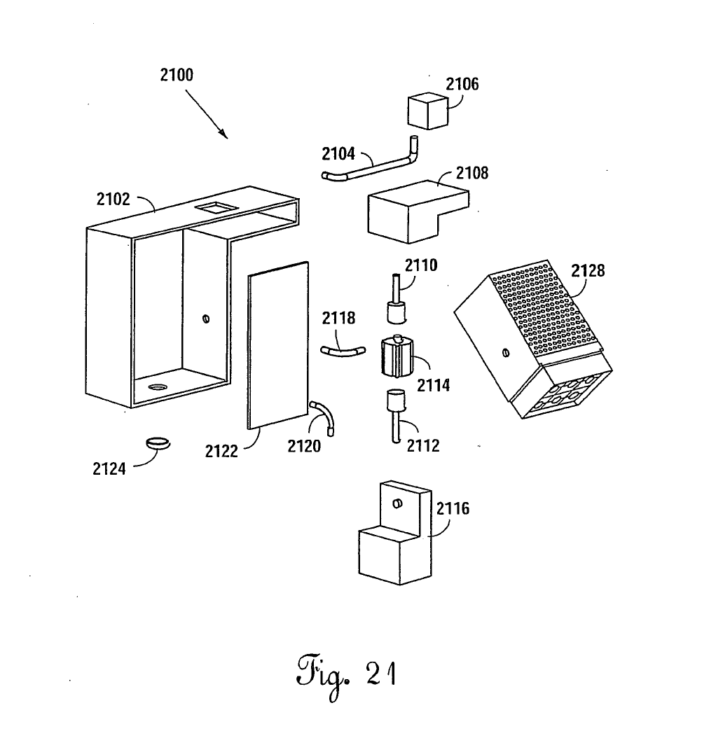

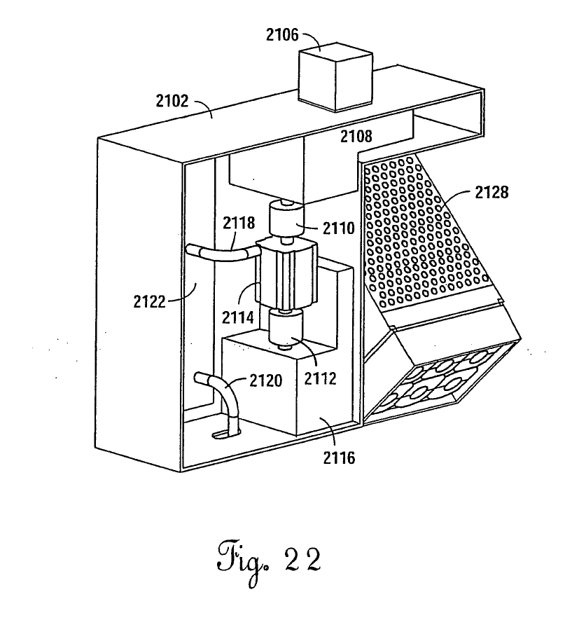

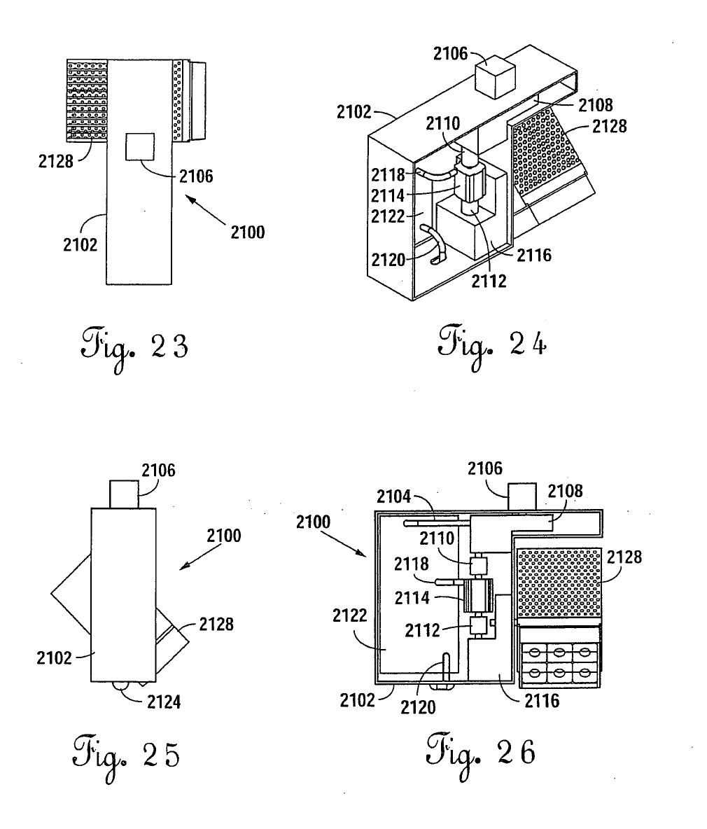

Referring now to FIGS. 21-27, one example of a lighting system 2100 that uses a single motor is described. In these examples, a single motor causes and drives both pan and tilt two-axis rotations of a lamp unit. The system 2100 includes a motor housing 2102, an input harness 2104, a track head 2106, a panning gear box 2108, a first clutch (or switch) 2110, a second clutch (or switch) 2112, a single motor 2114, a tilting gear box 2116, a motor harness 2118, a sensor harness 2120, a controller printed circuit board (PCB) assembly 2122, sensors 2124, a motor box cover (not shown, that covers the open box), and a LED lamp head 2128.

The motor housing 2102 is constructed of any material such as a metal or hard plastic. The input harness 2104 connects the PCB assembly 2122 to the panning gear box 2108. The track head 2106 head can include in one aspect a receiver for receiving signals from a remote unit, lamp units for illuminating a target object, control boards, and motors for adjusting the lamp units. The panning gear box 2108 is a set of gears that engages the LED lamp head to move in a horizontal (panning) direction. The first clutch 2110 and the second clutch 2112 are both disposed on the shaft of the motor 2114. The single motor 2114 is an electric motor configured to move a lamp via the gearing boxes. The tilting gear box 2116 includes gears that engage a lamp head to move in the vertical or tilting direction. The motor harness 2118 connects the motor 2114 to the PCB assembly 2122. The sensor harness 2120 connects the sensor 2124 to the PCB assembly 2122. The controller printed circuit board (PCB) assembly 2122 includes devices that control the operation of the motor. The sensors 2124 sense incoming signals from various sources including a remote control unit and an illumination target. The motor box cover covers the housing 2102 and is constructed of any suitable material such as metal or a hard plastic. The LED lamp head 2128 includes lamps (e.g., LEDs) and can be moved in tilt and pan directions.

The gearing boxes 2108 and 2116 include gears, for example, as have been described above that translate rotation of the motor 2114 into movement of the lamp head 2128 in either the horizontal or vertical directions. To take one example and as described elsewhere herein, worm gears may be used in the gear box that provides tilting. Other examples of gearing mechanisms are possible and can be used.

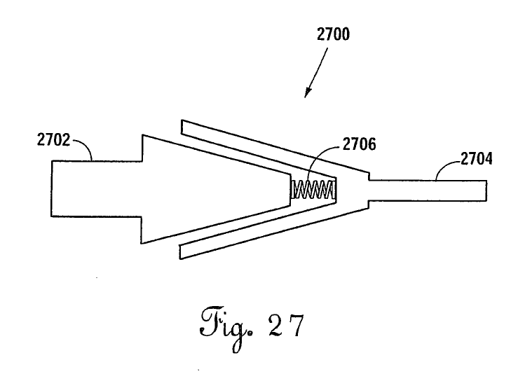

The mechanism by which the single motor moves the lamp head 2128 may vary. In one aspect, the mechanical clutches 2110 and 2112 on either side of the motor 2114 are engaged by the motor 2114, and the clutches in turn frictionally engage gearing mechanisms (within the gearing boxes) that in turn move the lamp head 2128 in a particular direction (tilt or pan). In one example and as explained below with respect to FIG. 27, a male and female trap cone shaped clutch is pushed by activation of the motor solenoid into engagement to generate the friction for the gears that in turn move the lamp head 2128. On the other hand, when the pressure is released by disengagement of the solenoid, the two portions (male and female) are not engaged and run freely.

The motor solenoid holds the motor vertically. The motor 2114 is a double shaft motor and at each shaft of the motor 2114 a friction device (e.g., clutches 2110 and 2112) is mounted. The motor 2114 is moved upwardly by activating its solenoid in a particular direction (e.g., by applying a predetermined voltage or current to the solenoid, the predetermined voltage or current being of a predetermined direction) to engage the horizontal gear for panning. The motor is moved downwardly to engage, for example, the worm gear for tilting for instance by driving the voltage (or current) applied to the solenoid in a different (e.g., the opposite) direction. For instance, voltage (or current) may be activated to move the motor 2114 upwardly (and engage the top clutch 2110) and activated in the opposition direction to move the motor 2114 downwardly (and engage the bottom clutch 2112).

As mentioned and as shown in FIG. 27, an electromagnetic clutch (switch) is used in some examples to engage the motor in rotation of the lamps. In this respect, the clutch (switch) includes male and female portions that are locked together or disengaged depending upon whether a particular axis rotation (pan or tilt) is desired. In other words, each of the clutches 2110 and 2112 has male and female portions. Only one clutch will be engaged at a time allowing tilting or panning motions to occur.

The switch 2700 includes a male portion 2702 and a female portion 2704. In one example, the male portion 2702 is permanent magnet and the female portion 2704 is a non-permanent magnet. When the voltage applies to the female portion 2704, it becomes magnet. More specifically, reversing the voltage polarity changes the north pole to the south pole and this change in voltage polarity alternatively engages or disengages the male section 2702 and the female section 2704. A spring 2706 provides tension as between the mail portion 2702 and the female portion 2704. The portion 2702 may be coupled to the motor. Once the portions are engaged and the motor is operation, the portion 2702 turns, which turns the portion 2704, which turns the gears of the appropriate gearing box, which moves the lamps in the appropriate direction (depending upon whether the upper or lower switch is selected).

As mentioned, the motor 2114 is a double shaft motor, and kept stationary in vertical position. Each end of motor will mount the custom electromagnetic switch. In one example, the top switch is used to actuate the horizontal gear (for panning) and the bottom switch is used to actuate the vertical gear (for tilting). For panning, voltage is applied to the top switch to engage the motor 2114 in horizontal rotation. This voltage is reversed to disengage the motor 2114 for panning in the horizontal direction. For tilting, voltage is applied to bottom switch to engage the motor 2114 in vertical rotation. This voltage is reversed to disengage the motor 2114 from tilting.

The present invention has been described above in terms of a presently preferred embodiment so that an understanding of the present invention can be conveyed. There are, however, many configurations for the system not specifically described herein but with which the present invention is applicable. The present invention should therefore not be seen as limited to the particular embodiments described herein, but rather, it should be understood that the present invention has wide applicability with respect to track light systems generally. All modifications, variations, or equivalent arrangements and implementations that are within the scopes of the attached claims should therefore be considered within the scope of the invention.

1. A track-light module comprising:
a lighting device;
a first electric motor mechanically coupled to said lighting device and configured to position said lighting device along a first direction;
a second electric motor mechanically coupled to said lighting device and configured to position said lighting device along a second direction;
a controller, wherein said controller is configured to receive one or more wireless control signals for controlling operation of at least one of said first electric motor and said second electric motor;
wherein said controller receives location information indicating a target object.

2. (canceled)

3. The track-light module of claim 1 wherein said controller is configured to actuate one or more of said first motor and said second motor to adjust a position of said lighting device to illuminate the target object in response to receiving and according to said location information.

4. The track-light module of claim 1 wherein said controller further includes an optical sensor for detecting backscatter illumination.

5. The track-light module of claim 1, wherein said first electric motor is configured to position said lighting device along a tilt axis.

6. The track-light module of claim 1, wherein said second electric motor is configured to position the light source along a pan axis.

7. The track light module of claim 1, wherein said controller further includes a laser source and wherein said controller is coupled to said laser source and is further configured to receive one or more wireless control signals for activating or de-activating said laser source.

8. The track-light module of claim 1, wherein said one or more wireless control signals includes at least one of the following: a radio-frequency (RF) signal, a Bluetooth signal, or a Zigbee® signal.

9. The track-light module of claim 1 wherein said one or more wireless control signals is an infrared (IR) signal.

10. The track-light module of claim 1, wherein said lighting device includes at least one light-emitting diode (LED).

11. The track-light module of claim 1 wherein said lighting device includes an LED PAR-30 lamp.

12. A method for positioning a lighting device of a light-track module to illuminate an illumination target comprising:
positioning the lighting device in a first orientation;
emitting light from the lighting device;
measuring, using one or more optical sensors, a first backscatter illumination intensity that is dispersed from the illumination target;
positioning the lighting device in a second orientation, wherein said second orientation is different from said first orientation;
measuring, using said one or more optical sensors, a second backscatter illumination intensity; and
comparing said first backscatter illumination intensity and said second backscatter illumination intensity.

13. The method of claim 12, further including, determining an original light source orientation based on the comparison of said first backscatter illumination intensity and said second backscatter illumination intensity.

14. The method of claim 12, wherein a sticker is placed on the illumination target.

15. The method of claim 12, wherein said lighting device is a laser.

16. The method of claim 12, wherein said lighting device is at least one light-emitting diode (LED).

17. The method of claim 12, wherein said lighting device is an LED type PAR-30 lamp.

18. A handheld control unit comprising:
a memory;
a controller electrically coupled to said memory and configured to receive and store information, wherein said stored information includes track head position settings relating to a position of a target object; and
a transmitter, electrically coupled to said controller and wherein said transmitter is configured to transmit at least a portion of the information to a track head control unit.

19. The handheld control unit of claim 18, wherein said transmitter is configured to transmit said track head position settings via one or more infrared (IR) signals.

20. The handheld control unit of claim 18 wherein said transmitter is configured to transmit said track head position settings via one or more radio-frequency (RF) signals.

21. A method of controlling a light fixture at a lighting control unit, the method comprising:
receiving a control signal from a remote control device;
responsively activating the light control unit to control a lighting device;
subsequent to said activating, transmitting a locator signal to a locator on a target object;
receiving a response signal from said target object in response to said transmitting;
based upon said response signal, adjusting one or more axis motors to aim said lighting device and illuminate said target object.

22. The method of claim 21 wherein said one or more axis motors is a single motor that adjusts the position of the lighting device relative to a pan and tilt axis.

23. The method of claim 21 wherein said one or more axis motors includes a first motor that adjusts a position of said lighting device along said pan axis and a second motor that adjusts the position of said lighting device along said tilt axis.

24. The method of claim 21 wherein said locator includes a passive locator or an active locator.

25. The method of claim 21 wherein said transmitting a locator signal includes transmitting a laser signal.

26. The method of claim 21 wherein said control signal is a laser signal or an infrared signal.

27. The method of claim 21 wherein said response signal includes backscattered radiation.

28. A track head unit that is configured to be coupled to a track, the track head unit comprising:
a lighting device;
a first sensor configured to receive transmissions from a portable remote control device;
a second sensor configured to receive transmissions associated with a target object;
one or more electric motors, wherein said one or more electric motors are mechanically coupled to said lighting device and are configured to position said lighting device along a first direction and a second direction;
a controller coupled to said lighting device, said first sensor, said second sensor, and said one or more electric motors, wherein said controller is configured to receive a control signal from said portable remote control device via said first sensor, responsively transmit a locator signal to a locator that is disposed at a target object, receive a response signal via said second sensor from said target object in response to said transmission, and based upon said response signal, actuate said one or more electric motors to aim said lighting device at said target object.

29. The track head unit of claim 28 wherein said one or more electric motors is a single electric motor.

30. The track head unit of claim 29 wherein said single electric motor adjusts the position of said lighting device relative to a pan axis and a tilt axis.

31. The track head unit of claim 29 wherein said single electric motor is a double shaft electric motor with a first shaft and a second shaft and wherein said first shaft couples to first clutch and said second shaft couples to a second clutch.

32. The track head unit of claim 31 wherein said first clutch couples to a first gearing arrangement and wherein said second clutch couples to a second gearing arrangement.

33. The track head unit of claim 32 wherein said first gearing arrangement is effective to turn said lighting device in a first direction and said second gearing arrangement is effective to turn said lighting device in a second direction.

34. The track head unit of claim 33 wherein said first clutch and said second clutch include a male portion and a female portion.

35. The track head unit of claim 28 wherein said one or more electric motors includes a first electric motor and a second electric motor.

36. The track head unit of claim 35, wherein said first motor adjusts a position of said lighting device along a pan axis and said second motor adjusts the position of said lighting device along a tilt axis.

37. The track head unit of claim 28 wherein said locator includes a passive locator or an active locator.

38. The track head unit of claim 28 wherein said controller is configured to transmit a laser signal.

39. The track head unit of claim 28 wherein said received control signal includes a laser signal or an infrared signal.

40. The track head unit of claim 28 wherein said response signal includes backscattered radiation.

41. The track head unit of claim 28, wherein said lighting device includes at least one light-emitting diode (LED).

42. The track head unit of claim 28, wherein said lighting device includes an LED type PAR-30 lamp.

43. The track-light module of claim 1 wherein said location information is received from said target object.

44. The track-light module of claim 1 wherein said location information includes a position of said target object.
